(19) United States
(12) Patent Application Publication
(10) Pub. No.: US 2020/0304278 A1
(43) Pub. Date: Sep. 24, 2020

(54) ARCHITECTURE FOR COMBINING FULL-DUPLEX AND FREQUENCY DIVISION DUPLEX COMMUNICATION SYSTEMS

(71) Applicant: Avago Technologies International Sales Pte. Limited, Singapore (SG)

(72) Inventors: Juo Jung HUNG, Irvine, CA (US); Massimo BRANDOLINI, Mission Viejo, CA (US); Giuseppe CUSMAI, Mission Viejo, CA (US); Chun-ying CHEN, Irvine, CA (US); Clint NEUZIL, Atlanta, GA (US)

(21) Appl. No.: 16/358,541

(22) Filed: Mar. 19, 2019

(51) Int. Cl. H04L 5/08; H04L 5/14

(52) U.S. Cl. CPC H04L 5/08; H04L 5/1438; H04L 5/143; H04L 5/1423

(57) ABSTRACT

An architecture for combining full-duplex and frequency division duplex communication systems, includes a coupler coupled to a terminal and configured to allow duplex transmissions of digital signals via the terminal. The subject architecture includes a filtering device coupled to the coupler and configured to divide a downstream signal received through the coupler into a plurality of downstream signals associated with a plurality of frequency ranges. The subject architecture includes a transmitter coupled to the coupler and configured to drive, through the coupler, an upstream signal comprising digital signals associated with the plurality of frequency ranges. The subject architecture also includes a plurality of receivers coupled to the filtering device and configured to receive respective ones of the plurality of downstream signals.

### TECHNICAL FIELD

The present disclosure relates to content distribution systems, and more particularly, but not exclusively, to an architecture for combining full-duplex and frequency division duplex communication systems.

### BACKGROUND

Modern cable television (CATV) systems provide not only one-way broadcast programming, but also high-speed two-way communications between customers and the Internet. Cable modems are a primary source of Internet connectivity for millions of consumers worldwide, backhauling local WiFi communications for residential and business customers. Modern high-spectral-efficiency CATV systems, such as those based on the Data Over Cable Service Interface Specification (DOCSIS) 3.1 standard that governs cable communications, increasingly depend on complex signal modulation, with high-order constellations, multi-carrier signaling and multi-channel aggregation.

### BRIEF DESCRIPTION OF THE DRAWINGS

Certain features of the subject technology are set forth in the appended claims. However, for purpose of explanation, one or more implementations of the subject technology are set forth in the following figures.

FIG. 1 illustrates an example network environment in which a content distribution system may be implemented in accordance with one or more implementations of the subject technology.

FIG. 2 illustrates an example content distribution system in accordance with one or more implementations of the subject technology.

FIG. 3A conceptually illustrates the layout of a traditional hybrid optical-fiber/coaxial cable CATV distribution architecture in accordance with one or more implementations of the subject technology.

FIG. 3B is a diagram illustrating an example of a communication device operative within one or more communication systems.

FIG. 4A illustrates an example of a continuous multicarrier spectrum based on a frequency division duplex communication system in accordance with one or more implementations of the subject technology.

FIG. 4B illustrates an example architecture for a frequency division duplex communication system in accordance with one or more implementations of the subject technology.

FIG. 5A illustrates an example of a continuous multicarrier spectrum based on a full-duplex communication system in accordance with one or more implementations of the subject technology.

FIG. 5B illustrates an example architecture for a full-duplex communication system in accordance with one or more implementations of the subject technology.

FIG. 6A illustrates an example of a continuous multicarrier spectrum based on a combination of full-duplex and frequency division duplex communication systems in accordance with one or more implementations of the subject technology.

FIG. 6B illustrates an example architecture for combining full-duplex and frequency division duplex communication systems in accordance with one or more implementations of the subject technology.

FIB. 6C illustrates another example architecture for combining full-duplex and frequency division duplex communication systems in accordance with one or more implementations of the subject technology.

FIG. 7 conceptually illustrates an electronic system with which any implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more implementations. In one or more instances, structures and components are shown in block diagram form in order to avoid obscuring the concepts of the subject technology.

In a content distribution system defined by the DOCSIS 3.1 standard, significant challenges exist when Full-Duplex (FDX) and Frequency Division Duplex (FDD) communication systems are combined. For example, any components of the content distribution system such as a frequency-domain multiplexing device in the FDD communication system that causes transmitter signal reflection severely limits the signal-to-noise performance that can be achieved in the FDX communication system.

To address this challenge, the present disclosure provides for an architecture that combines the FDD and FDX communication systems that maximizes the signal-to-noise ratio (SNR) of the FDX transmission without being affected by the input reflection of any filtering components in the FDX signal path. The architecture of the subject technology reduces the design complexity required for a transmitter by reducing the number of power amplifiers utilized and reducing the input return loss of the FDX/FDD communication system. In the subject technology, the architecture includes a coupler coupled to a terminal and configured to allow duplex transmissions of digital signals via the terminal. The subject architecture includes a filtering device coupled to the coupler and configured to divide a downstream signal received through the coupler into a plurality of downstream signals associated with a plurality of frequency ranges. The subject architecture includes a transmitter coupled to the coupler and configured to drive, through the coupler, an upstream signal comprising digital signals associated with the plurality of frequency ranges. The subject architecture also includes a plurality of receivers coupled to the filtering device and configured to receive respective ones of the plurality of downstream signals.

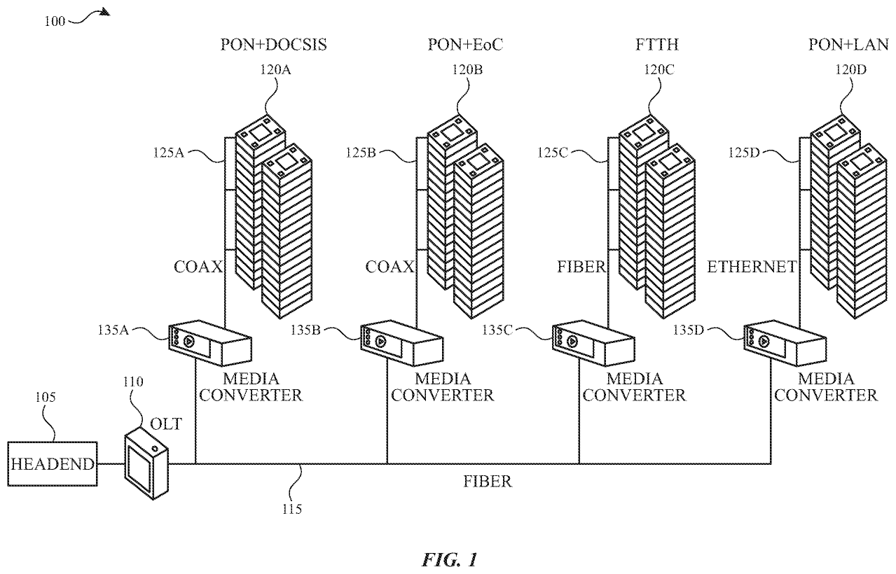

FIG. 1 illustrates an example network environment 100 in which a content distribution system may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 100 includes a headend 105, an optical line terminal (OLT) 110, buildings 120A-D, media converters 135A-D, a first transmission network 115, and second transmission networks 125A-D. The buildings 120A-D may be multi-dwelling units (MDUs), houses, offices, or any general structures. In one or more implementations, one or more of the buildings 120A-D may represent a collection of separate structures, such as a subdivision of separate houses. In one or more implementations, the media converters 135A-D generally refer to “fiber nodes,” where a transmission media over fiber is redistributed to a transmission media over coaxial cable, and vice versa.

The buildings 120A-D may include multiple gateway devices that are located in different units of the buildings 120A-D, such as different offices, different dwelling units, etc. The gateway devices may be coupled to the media converters 135A-D via the second transmission networks 125A-D and may be coupled to one or more user devices within the different units via local area networks. The second transmission networks 125A-D may include network couplings and/or adapters, such as splitters, and may include any network medium, such as coaxial transmission lines, fiber optic transmission lines, Ethernet transmission lines, power transmission lines, etc. In one or more implementations, the second transmission networks 125A-D may include a non-optical network medium, such as coaxial transmission lines.

In the network environment 100, the second transmission network 125A is represented as a DOCSIS network that includes coaxial transmission lines, the second transmission network 125B is represented as a Ethernet over Coxial (EoC) network that includes coaxial transmission lines, the second transmission network 125C is represented as part of a fiber to the home (FTTH) network that includes fiber optic transmission lines, and the second transmission network 125D is represented as a local area network (LAN) that includes Ethernet transmission lines.

The media converters 135A-D may be coupled to the gateway devices via the second transmission networks 125A-D and may be coupled to the OLT 110 via the first transmission network 115. The first transmission network 115 may include one or more network couplings, or adapters, such as splitters, and may include any network medium, such as coaxial transmission lines, fiber optic transmission lines, Ethernet transmission lines, power transmission lines, etc. In one or more implementations, the first transmission network 115 may include an optical network medium and one or more optical splitters. In one or more implementations, the second network medium may be different than the first network medium. In the network environment 100, the first transmission network 115 is represented as a passive optical network (PON) that includes fiber optic transmission lines.

Since the media converters 135A-D are coupled to the gateway devices via the second transmission networks 125A-D, and to the OLT 110 via the first transmission network 115, the media converters 135A-D may convert signals received over the first transmission network 115, such as optical signals, to signals that can be transmitted over the second transmission networks 125A-D, such as electric signals. In one or more implementations, the media converters 135A-D may act as layer-2 bridges, which receive data packets from the OLT 110 of the headend 105 over optical network medium of the first transmission network 115, and bridge the received data packets over the non-optical network medium of the second transmission networks 125A-D to the gateways, and vice-versa.

The headend 105 may include one or more devices, such as network devices, transmitters, receivers, servers, etc., that are part of a content delivery network (CDN) that coordinates the delivery of content items, such as television programs, movies, songs or other audio programs, educational materials, community information, or generally any content items, to the user devices of the buildings 120A-D. The content items may be delivered to the user devices via any content delivery mechanism. The headend 105 may use the OLT 110 to communicate over the first transmission network 115 with the media converters 135A-D.

The media converters 135A-D and the gateway devices may each include local caches, such as hard drives or other memory devices, for storing content items received from the headend 105 that are intended for distribution to the user devices. For example, the headend 105 may transmit content items that are expected to be requested by the user devices, such as popular movies, television shows, etc., to the media converters 135A-D and/or the gateway devices during off-peak hours. For example, if the headend 105 determines that there is a popular television series for which a not-yet-aired episode is expected to be requested by many of the user devices when the episode airs (or otherwise becomes available), the headend 105 may transmit the not-yet-aired episode to one or more of the media converters 135A-D and/or one or more of the gateways during off-peak hours, such as the night before the episode is scheduled to air (or otherwise become available). In this manner, the simultaneous viewing of the episode by many of the user devices the next day will not overwhelm the first transmission network 115 and/or the second transmission networks 125A-D. Similarly, if a user device is accessing an episode television series on-demand, the headend 105 can coordinate caching one or more subsequent episodes to a media converter 135A and/or a gateway device that is upstream from the user device.

In one or more implementations, the headend 105 may receive an indication from a third party server, such as a content provider server, that a particular content item is expected to be requested by multiple user devices. For example, the headend 105 may receive an indication from an audio content provider that an upcoming release of a song and/or album of a certain artist or style is expected to be requested by many of the user devices. The headend 105 may then transmit the song and/or album to the media converters 135A-D and/or the gateway devices in advance of the release date, such as the night before, e.g. an during off-peak, or low traffic, time period.

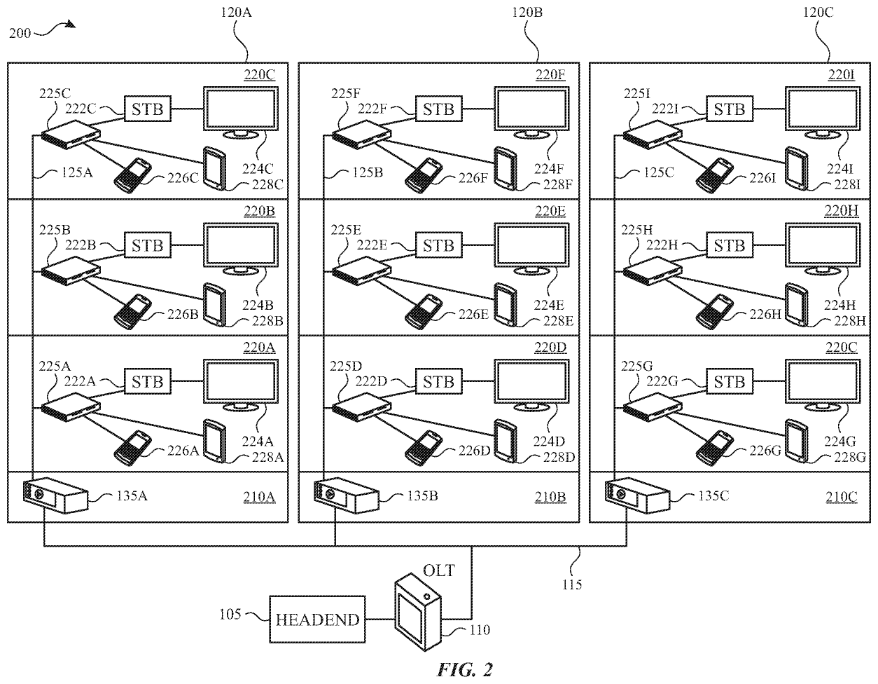

FIG. 2 illustrates an example content distribution system 200 in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example content distribution system 200 includes the headend 105, the OLT 110, the buildings 120A-C, the first transmission network 115 and the second transmission networks 125A-C. The buildings 120A-C include utility areas 210A-C and units 220A-I. The units 220A-I may include gateway devices 225A-I, electronic devices 222A-I, 226A-I, 228A-I, and display devices 224A-I.

The utility areas 210A-C may be common areas of the buildings 120A-C, e.g. areas of the buildings 120A-C that are accessible to utility operators, such as broadband service providers. In one or more implementations, the utility areas 210A-C may be in the basement of the buildings 120A-C or external to the buildings 120A-C. The units 220A-I of the buildings 120A-C may be dwelling units, office spaces, or generally any delineated structures within the buildings 120A-C. In one or more implementations, one or more of the buildings 120A-C may represent a collection of physically separate units 220A-I, such as a subdivision of separate houses.

The gateway devices 225A-I may include a network processor or a network device, such as a switch or a router, that is configured to couple the electronic devices 222A-I, 226A-I, 228A-I to the headend 105 via the media converters 135A-C. The gateway devices 225A-I may include local area network interfaces, such as wired interfaces and/or wireless access points, for communicating with the electronic devices 222A-I, 226A-I, 228A-I. The gateway devices 225A-I may include a local cache for caching content items and/or portions of content items, and the gateway devices 225A-I may include distribution control modules for coordinating the caching of the content items.

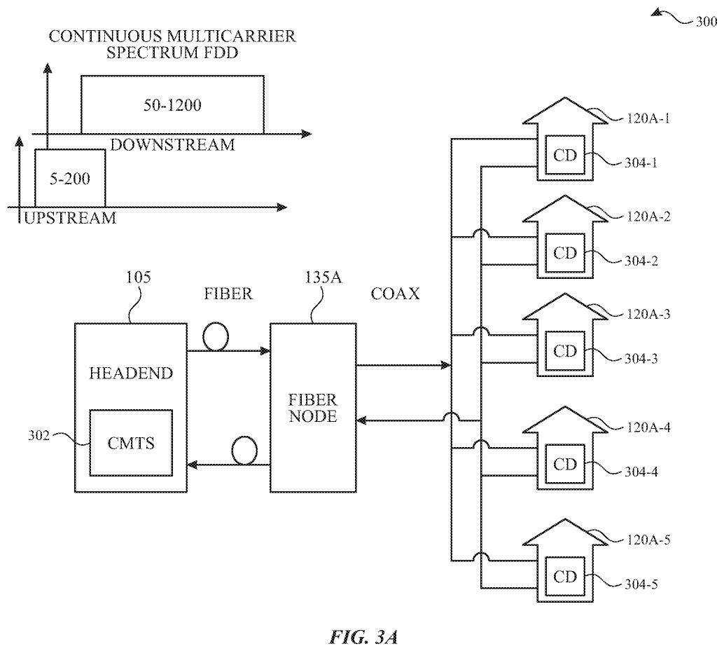

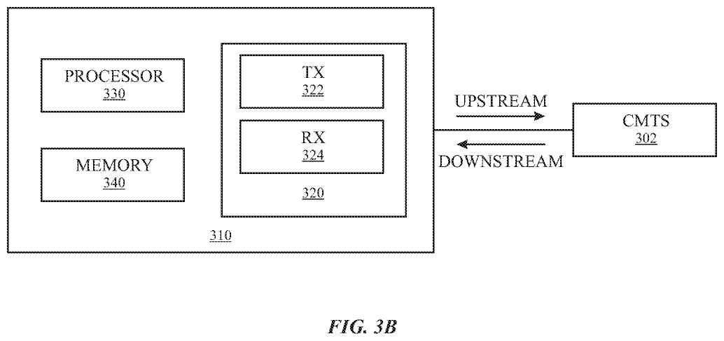

The electronic devices 222A-I, 226A-I, 228A-I can be computing devices such as laptop or desktop computers, smartphones, personal digital assistants (“PDAs”), portable media players, set-top boxes, tablet computers, televisions or other displays with one or more processors coupled thereto and/or embedded therein, or other appropriate computing devices that can be used for adaptive bit rate streaming, and rendering, of multimedia content and/or can be coupled to such a device. In the example of FIG. 2, the electronic devices 222A-I are depicted as set-top boxes (STBs) that are coupled to display devices 224A-I, such as televisions, the electronic devices 226A-I are depicted as smart phones, and the electronic devices 226A-I are depicted as tablet devices. In one or more implementations, any of the electronic devices 222A-I, 226A-I, 228A-I may be referred to as a user device and any of the electronic devices 222A-I, 226A-I, 228A-I may be, or may include one or more components of, the electronic system that is discussed below with respect to FIG. 3.

As shown in FIG. 2, the headend 105, media converters 135A-C, gateway devices 225A-I, and electronic devices 222A-I, 226A-I, 228A-I are arranged in a hierarchical tree network arrangement such that the headend 105 is directly coupled to the media converters 135A-C, the media converter 135A is directly coupled to the gateway devices 225A-C, the media converter 135B is directly coupled to the gateway devices 225D-F, the media converter 135C is directly coupled to the gateway devices 225G-I, the gateway device 225A is directly coupled to the electronic devices 222A, 226A, 228A, the gateway device 225B is directly coupled to the electronic devices 222B, 226B, 228B, etc. In other words, the headend 105 is located directly upstream from the media converters 135A-C, the media converter 135A is located directly upstream from the gateway devices 225A-C, the media converter 135B is located directly upstream from the gateway devices 225D-F, the media converter 135C is located directly upstream from the gateway devices 225G-I, the gateway device 225A is located directly upstream from the electronic devices 222A, 226A, 228A, the gateway device 225B is located directly upstream from the electronic devices 222B, 226B, 228B, etc.

The media converters 135A-C and/or the gateway devices 225A-I, may each include a cache, such as a hard drive or other memory device, that stores content items, and/or portions thereof, intended for distribution from the headend 105 to one or more of the electronic devices 222A-I, 226A-I, 228A-I. Thus, the caching of the content items is distributed across two layers of network nodes in the hierarchical network arrangement, first the media converters 135A-C and then the gateway devices 225A-I. If a content item that is cached by a media converter 135A or a gateway device 225A is requested by an electronic device 222A, the content item is provided to the electronic device 222A by the media converter 135A or the gateway device, rather than by the headend 105, thereby conserving upstream bandwidth.

The headend 105 may communicate with distribution control modules of the media converters 135A-C to coordinate caching the content items at the media converters 135A-C. The distribution control modules of the media converters 135A-C may also coordinate the caching of content in the subset of the downstream gateway devices 225A-I that are directly coupled to the media converters 135A-C. For example, the media converter 135A may coordinate the caching of content in the gateway devices 225A-C. The distribution control modules of the media converters 135A-C may communicate with distribution control modules of the gateway devices 225A-I to coordinate caching content items at the gateway devices 225A-I. The headend 105 and the distribution control modules of the media converters 135A-C and the gateway devices 225A-I are discussed further below with respect to FIG. 3.

The headend 105 and/or the distribution control modules of the media converters 135A-C may control the distribution of the caching such that content items, or portions thereof, that are expected to be requested by one or more of the electronic devices 222A-I, 226A-I, 228A-I are cached at the media converters 135A-C and/or the gateway devices 225A-I that service, e.g. are directly upstream from, the electronic devices 222A-I, 226A-I, 228A-I, prior to the content items, or portions thereof, being requested by the electronic devices 222A-I, 226A-I, 228A-I. For example, when an electronic device 222A requests a content item, or a portion thereof, from the headend 105 that is cached at the gateway device 225A, or the media converter 135A, that services the electronic device 222A, the gateway device 225A or media converter 135A can intercept the request, e.g. since the request will be transmitted to the headend 105 via the gateway device 225A and the media converter 135A, and the gateway device 225A or the media converter 135A can provide the cached content item, or portion thereof, to the electronic device 222A, instead of transmitting the request back to the headend 105. In this manner requested content items can be provided to the electronic devices 222A-I, 226A-I, 228A-I from a proximal network node, thereby reducing upstream congestion.

In one more implementations, the headend 105, and/or the distribution control modules of the media converters 135A-C and/or the gateway devices 225A-I may collectively maintain a cache directory of cached content items. The cache directory may be locally stored at the headend 105, and/or at the distribution control modules of one or more of the media converters 135A-C and/or the gateway devices 225A-I. The cache directory may include, for example, an identification of each cached content item, or portion thereof, and a network identifier, such as a uniform resource locator (URL), for accessing the content item, or portion thereof. The gateway devices 225A-I and/or the media converters 135A-C may utilize content redirection techniques, such as hypertext transport protocol (HTTP) redirection techniques, to allow the electronic devices 222A-I, 226A-I, 228A-I to access content items that are cached at the media converters 135A-C and/or at the gateway devices 225A-I that are not directly upstream from the electronic devices 222A-I, 226A-I, 228A-I.

For example, a gateway device 225D and/or a media converter 135B that are located directly upstream from an electronic device 222D may intercept a request for a content item, or portion thereof, from the electronic device 222D. If the requested content item is not cached at the gateway device 225D or the media converter 135B, the gateway device 225D and/or the media converter 135B may determine, based on the locally stored cache directory, whether the requested content item is cached at another media converter 135A,C or gateway device 225A-C, E-I. If the requested content item is cached at another media converter 135A,C or gateway device 225A-C, E-I, the gateway device 225D and/or the media converter 135B may utilize an HTTP redirection technique to redirect the request of the electronic device 222D from the headend 105 to the another media converter 135A,C or gateway device 225A-C, E-I, such as the media converter 135A.

The headend 105 may partition the electronic devices 222A-I, 226A-I, 228A-I into groups based on the content items that are expected to be requested by the electronic devices 222A-I, 226A-I, 228A-I. For example, the electronic devices 222A-I, 226A-I, 228A-I may be partitioned into groups based on characteristics associated with the electronic devices 222A-I, 226A-I, 228A-I and/or characteristics associated with the users interacting with the electronic devices 222A-I, 226A-I, 228A-I, such as the level of service, e.g. channel tier, accessible to the electronic devices 222A-I, 226A-I, 228A-I, e.g. via subscriptions, the physical locations of the electronic devices 222A-I, 226A-I, 228A-I, the demographics of the users interacting with the electronic devices 222A-I, 226A-I, 228A-I, content items previously accessed by the electronic devices 222A-I, 226A-I, 228A-I, such as episodes of a serial television program, or generally any characteristics that are indicative of content items that may be requested in the future by the electronic devices 222A-I, 226A-I, 228A-I.

For a given group of the electronic devices 222A-I, 226A-I, 228A-I, such as the group of the electronic devices 222A-I, 226D-F, 228D-F that can access a particular channel tier, the headend 105 may determine one of the media converters 135A-C that provides service to, e.g. is directly upstream from, the largest number of the electronic devices 222A-I, 226D-F, 228D-F in the group. Since the media converter 135B provides service to nine out of fifteen of the electronic devices 222A-I, 226D-F, 228D-F in the group, e.g. the electronic devices 222D-F, 226 D-F, 228D-F, the headend 105 may determine the media converter 135B.

Once the media converters 135A-C receive content items, and/or portions thereof, to be cached from the headend 105, the distribution control modules of the media converters 135A-C may identify content items that can be cached downstream at one or more of the gateway devices 225A-I, such as content items that are only expected to be accessed by a single electronic device 222A. The media converters 135A-C may determine that a particular content item is only expected to be accessed by a single electronic device 222A based at least in part on content access patterns of the electronic devices 222A-I, 226D-F, 228D-F in the group. In one or more implementations, the content access patterns of the electronic devices 222A-I, 226D-F, 228D-F in the group may be determined by one or more of the media converters 135A-C and/or the gateway devices 225A-I, by sniffing the network protocol messages that pass through the media converters 135A-C and/or gateway devices 225A-I. The distribution control modules of the media converters 135A-C may coordinate moving these content items from the cache of the media converters 135A-C to the cache of one or more of the gateway devices 225A-I. The distribution controllers of the media converters 135A-C may then coordinate with the distribution server of the headend 105 to receive additional content items, or portions thereof, to cache, e.g. in the cache space vacated by pushing the content item down to the one or more gateway devices 225A-I.

For example, a media converter 135B may determine that a content item can be cached at one of the gateway devices 225A-I, such as the gateway device 225D, when the content item is expected to be primarily accessed by the electronic devices 222D, 226D, 228D that are directly downstream from the gateway device 225D. In one or more implementations, a content item may be cached at a gateway device 225D if the content item is expected to be primarily accessed by the electronic devices 222D, 226D, 228D that are directly downstream from the gateway device 225D, and/or by the electronic devices 222E-F, 224E-F, 228E-F that are directly downstream from the gateway devices 225E-F that are directly coupled to the gateway device 225D, e.g. via the second transmission network 125B.

In one or more implementations, distribution control modules of the gateway devices 225A-I may communicate directly with the headend 105, e.g. via a distribution control module of one of the media converters 135A-C, in order to coordinate caching content items on the gateway device that are expected to be accessed by electronic devices 222A-I, 226A-I, 228A-I that are served by the gateway device, such as based on content access patterns of the electronic devices 222A-I, 226A-I, 228A-I. For example, if a gateway device 225A includes, or is coupled to, a set-top box that is configured to record a television show on a weekly basis, the gateway device 225A may coordinate with the headend 105 in order to have the television program cached on the gateway device 225A prior to its air time, e.g. during off-peak hours. Similarly, if an electronic device 222A is accessing an episode of a television series on-demand via a gateway device 225A, the gateway device 225A may coordinate with the headend 105 to cache subsequent episodes of the television series, e.g. during off-peak hours. In one or more implementations, the gateway device 225A may determine the content access patterns of the electronic devices 222A, 226A, 228A served by the gateway device 225A by sniffing the network protocol messages that pass through the gateway device 225A.

FIG. 3A conceptually illustrates the layout of a traditional hybrid optical-fiber/coaxial cable CATV distribution architecture 300 in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

A cable modem system is typically housed in a hybrid fiber/coaxial cable distribution architecture, such as the hybrid optical-fiber/coaxial cable CATV distribution architecture 300. The hybrid optical-fiber/coaxial cable CATV distribution architecture 300 consists of a fiber portion and a coaxial portion. The headend 105 is housed in the fiber portion of the hybrid optical-fiber/coaxial cable CATV distribution architecture 300. The headend 105 may provide operation of a cable modem termination system (CMTS). For example, the headend 105 may perform such CMTS functionality, or a CMTS 302 may be included in the headend 105 or may be implemented in a remotely distributed architecture between the headend 105 and other network segments. In other implementations, the CMTS 302 may be included in the fiber node (e.g., 135). The CMTS 302 can provide network service (e.g., Internet, other network access, etc.) to any number of cable modems (e.g., the communication devices 304-1, 304-2, 304-3, 304-4, 304-5) via a cable modem network segment. The network segment over which the CMTS 302 and the cable modems communicate is referred to as a hybrid optical-fiber/coaxial cable network (e.g., including various wired and/or optical fiber communication segments, light sources, light or photo detection components, etc.).

As depicted in FIG. 3A, the CMTS 302 is located within the headend 105, and services a plurality of cable modems (e.g., the communication devices 304-1, 304-2, 304-3, 304-4, 304-5), located in the coaxial portion of the hybrid fiber/coaxial cable distribution architecture via a plurality of fiber nodes in a point-to-multipoint topology. As depicted in FIG. 3, customer-premise cable modems and set-top boxes (e.g., communication devices 304-1, 304-2, 304-3, 304-4, 304-5) in a community (e.g., buildings 120A-1, 120A-2, 120A-3, 120A-4, 120A-5) communicate with a fiber node 135A, which is, or includes at least a portion of, the media converter 135A, via a shared coaxial cable. The fiber node 135A then communicates two-way traffic with the cable headend 105, similar in function to the wireline telephone central office.

In some implementations, the CMTS 302 may be a component that exchanges digital signals with cable modems on the hybrid fiber/coaxial cable distribution architecture. Each of the cable modems is coupled to the hybrid fiber/coaxial cable distribution architecture, and a number of elements may be included within the hybrid fiber/coaxial cable distribution architecture. For example, routers, splitters, couplers, relays, and amplifiers may be contained within the hybrid fiber/coaxial cable distribution architecture. In some aspects, downstream information may be viewed as that which flows from the CMTS 302 to the connected cable modems, and upstream information as that which flows from the cable modems to the CMTS 302.

Typically, bandwidth is available to transmit signals downstream from the headend 105 to the cable modems, such as the communication devices 304-1, 304-2, 304-3, 304-4, 304-5. However, in the upstream, bandwidth is limited and is arbitrated among the competing cable modems in the system. Cable modems request bandwidth from the CMTS 302 prior to transmitting data to the headend 105. The CMTS 302 allocates bandwidth to the cable modems based on availability and the competing demands from other cable modems in the system. The DOCSIS 3.1 standard uses frequency bands of approximately 5-200 MHz and 50-1200 MHz for upstream (customer to headend 105) and downstream (headend 105 to customer) signals, respectively.

FIG. 3B is a diagram illustrating an example of a communication device 310 operative within one or more communication systems. In some implementations, the communication device 310 is, or includes at least a portion of, the communication devices 304-1, 304-2, 304-3, 304-4, 304-5. The communication device 310 includes a communication interface 320 and a processor 330. The communication interface 320 includes functionality of a transmitter 322 and a receiver 324 to support communications with one or more other devices within a communication system. The communication device 310 may also include memory 340 to store information including one or more signals generated by the communication device 310 or such information received from other devices (e.g., the headend 105 and/or the fiber node 135A) via one or more communication channels. The memory 340 may also include and store various operational instructions for use by the processor 330 in regards to the processing of messages and/or other received signals and generation of other messages and/or other signals including those described herein. The memory 340 may also store information including one or more types of encoding, one or more types of symbol mapping, concatenation of various modulation coding schemes, etc. as may be generated by the communication device 310 or such information received from other devices via one or more communication channels. The communication interface 320 supports communications to and from one or more other devices (e.g., the headend 105 and/or other communication devices). Operation of the communication interface 320 may be directed by the processor 330 such that processor 330 transmits and receives signals (TX(s) and RX(s)) via the communication interface 320.

In some implementations, the communication interface 320 is implemented to perform any such operations of an analog front end (AFE) and/or physical layer (PHY) transmitter, receiver, and/or transceiver. Examples of such operations may include any one or more of various operations including conversions between the frequency and analog or continuous time domains (e.g., such as the operations performed by a digital to analog converter (DAC) and/or an analog to digital converter (ADC)), gain adjustment including scaling, filtering (e.g., in either the digital or analog domains), frequency conversion (e.g., such as frequency upscaling and or frequency downscaling, such as to a baseband frequency at which one or more of the components of the communication device 310 operates), equalization, pre-equalization, metric generation, symbol mapping and/or de-mapping, automatic gain control (AGC) operations, and/or any other operations that may be performed by an AFE and/or PHY component within a communication device.

In some implementations, the communication device 310 includes a frequency diplexer (or alternatively, another filtering device, such as a frequency triplexer) that services both upstream and downstream communications to and from the fiber node 135A.

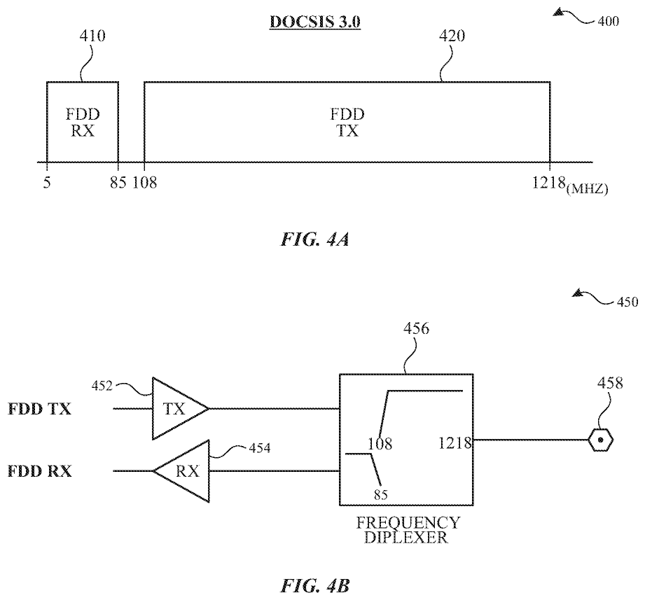

FIG. 4A illustrates an example of a continuous multicarrier spectrum 400 based on a frequency division duplex communication system in accordance with one or more implementations of the subject technology. The frequency division duplex communication system uses frequency bands of approximately 5-85 MHz (depicted as FDD RX 410) and 108-1218 MHz (depicted as FDD TX 420) for downstream (headend 105 to customer) and upstream (customer to headend 105) signals, respectively.

FIG. 4B illustrates an example architecture of a frequency division duplex communication system 450 in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The frequency division duplex communication system 450 includes a transmitter 452 (TX), a receiver 454 (RX), and a diplexer 456. In some implementations, the frequency division duplex communication system 450 is, or includes a portion of, the communication device 310 as depicted in FIG. 3B. In some aspects, the frequency division duplex communication system 450 includes an F-connector 458. In some implementations, the F-connector 458 is a coaxial RF connector commonly used for “over the air” terrestrial television, cable television and universally for satellite television and cable modems, usually with RG-6/U cable or, in older installations, with RG-59/U cable. Note that any other type of connector may be used in various applications. In some aspects, the receiver 454 may process, demodulate, decode, and/or interpret signals received via the F-connector 458 and the diplexer 456.

The diplexer 456 services both upstream and downstream communications to and from the fiber node 135A. The receiver 454 receives and samples signals from the diplexer 456 and may provide them to a processor (e.g., 330) for downstream processing. The received signals for downstream processing may first be filtered by the diplexer 456 to provide received signals within the downstream frequency range (e.g., between 5-85 MHz) and passed on to the receiver 454. The processor 330 may generate digital signals for upstream transmission, and the transmitter 452 may generate amplified analog or continuous-time signals there from. The digital signals for upstream transmission may be filtered by the diplexer 456 to provide digital signals within the upstream frequency range (e.g., between 108-1218 MHz) to the fiber node 135A. The transmitter 452 may be implemented as a power amplifier to amplify the analog or continuous-time signals.

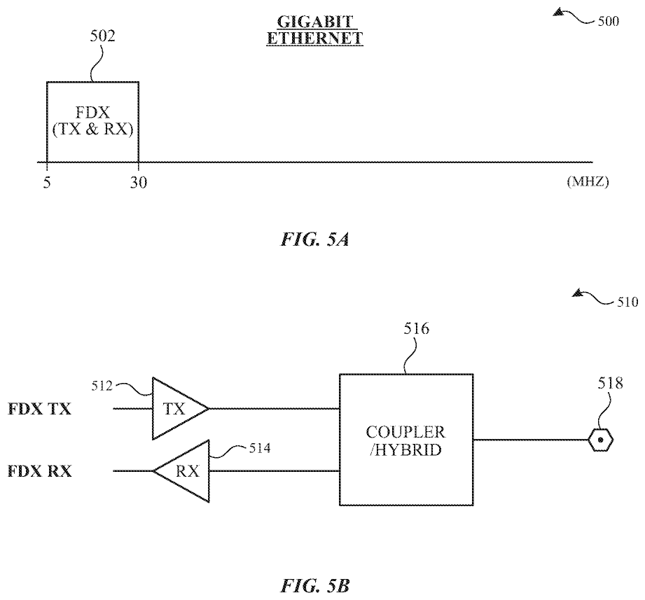

FIG. 5A illustrates an example of a continuous multicarrier spectrum 500 based on a full-duplex communication system in accordance with one or more implementations of the subject technology. The full-duplex communication system uses a frequency band of approximately 5-30 MHz (depicted as FDX TX/RX 502) for both downstream (headend 105 to customer) and upstream (customer to headend 105) signals, transmitted simultaneously.

FIG. 5B illustrates an example architecture of a full-duplex communication system 510 in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The full-duplex communication system 510 includes a transmitter 512 (TX), a receiver 514 (RX), and a coupler 516. In some implementations, the full-duplex communication system 510 is, or includes a portion of, the communication device 310 as depicted in FIG. 3B. In some aspects, the full-duplex communication system 510 includes an F-connector 518. Note that any other type of connector may be used in various applications. In some aspects, the receiver 514 may process, demodulate, decode, and/or interpret signals received via the F-connector 518 and the coupler 516.

The coupler 516 services both upstream and downstream communications to and from the fiber node 135A. The receiver 514 receives and samples signals from the coupler 516 and may provide them to a processor (e.g., 330) for downstream processing. The processor 330 may generate digital signals for upstream transmission, and the transmitter 512 may generate amplified analog or continuous-time signals there from. The transmitter 512 may be implemented as a power amplifier to amplify the analog or continuous-time signals. The coupler 516 may be a bi-directional coupler that allows duplex transmission over the communication medium to and from the fiber node 135A. The coupler 516 facilitates duplex transmission of the digital signals within the full-duplex frequency range (e.g., between 5-30 MHz).

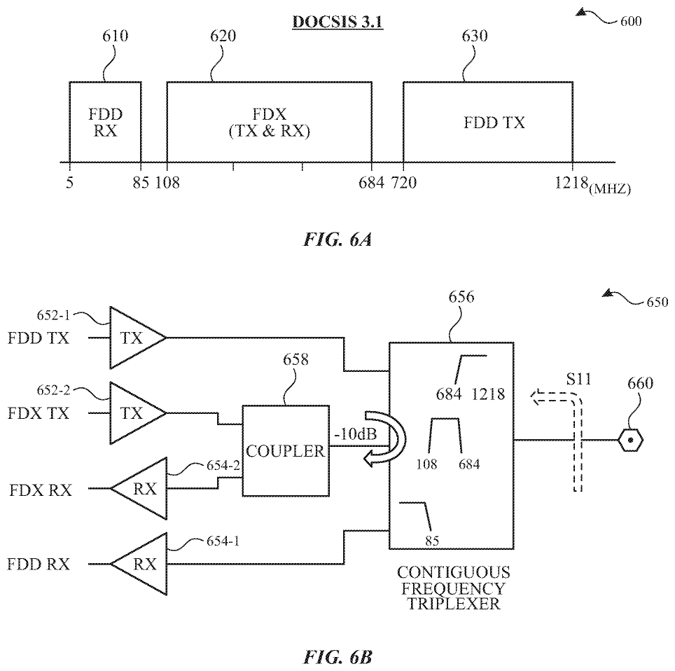

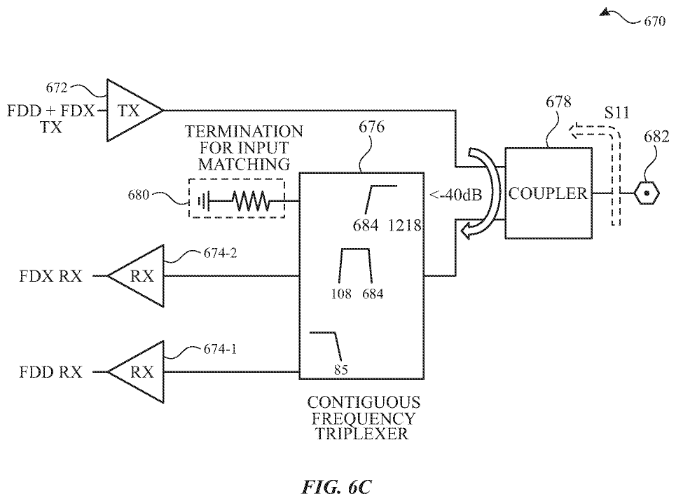

FIG. 6A illustrates an example of a continuous multicarrier spectrum 600 based on a combination of full-duplex and frequency division duplex communication systems in accordance with one or more implementations of the subject technology. The full-duplex and frequency division duplex communication systems use frequency bands of approximately 5-85 MHz (depicted as FDD RX 610), 108-684 MHz (depicted as FDX TX/RX 620), and 720-1218 MHz (depicted as FDD TX 630) for downstream FDD, full-duplex, and upstream FDD signals, respectively.

FIG. 6B illustrates an example combined architecture of full-duplex and frequency division duplex communication system 650 in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The full-duplex and frequency division duplex communication system 650 includes transmitters 652-1 and 652-2, receivers 654-1 and 654-2, a coupler 658 and a triplexer 656. In some implementations, the full-duplex and frequency division duplex communication system 650 is, or includes a portion of, the communication device 310 as depicted in FIG. 3B. The transmitter 652-1 services upstream FDD transmissions and is coupled directly to an input of the triplexer 656. The transmitter 652-2 services upstream FDX transmissions and is coupled directly to an input of the coupler 658. The receiver 654-1 services downstream FDD transmissions and is coupled directly to an output of the triplexer 656. The receiver 654-2 services downstream FDX transmissions and is coupled directly to an output of the coupler 658. The coupler 656 may be a bi-directional coupler that allows duplex transmission over the communication medium to and from the fiber node 135A. The coupler 658 is coupled directly to a bidirectional port of the triplexer 656 to facilitate the full-duplex transmissions to and from the receiver 654-2 and transmitter 652-2, respectively. In some aspects, the full-duplex and frequency division duplex communication system 650 includes an F-connector 660. Note that any other type of connector may be used in various applications. In some aspects, the receivers 654-1 and 654-2 may process, demodulate, decode, and/or interpret signals received via the F-connector 658 and the triplexer 656.

The triplexer 656 services both upstream and downstream communications to and from the fiber node 135A. The receivers 654-1 and 654-2 receive and sample signals from the triplexer 656 and may respectively provide them to a processor (e.g., 330) for downstream processing. The received signals for downstream FDD processing may be filtered by the triplexer 656 to provide received signals within the downstream FDD frequency range (e.g., between 5-85 MHz) and passed on to the receiver 654-1. The received signals for downstream FDX processing may be filtered by the triplexer 656 to provide received signals within the downstream FDX frequency range (e.g., between 108-684 MHz) and passed on to the receiver 654-2. The processor 330 may generate digital signals for upstream transmission, and the transmitters 652-1 and 652-2 may generate amplified analog or continuous-time signals there from. The digital signals sent from the transmitter 652-1 for upstream FDD transmission may be filtered by the triplexer 656 to provide digital signals within the upstream FDD frequency range (e.g., between 720-1218 MHz) to the fiber node 135A. The digital signals sent from the transmitter 652-2 for upstream FDX transmission may be filtered by the triplexer 656 to provide digital signals within the upstream FDX frequency range (e.g., between 108-684 MHz) to the fiber node 135A. Each of the transmitters 652-1 and 652-2 may be implemented as a power amplifier to amplify the analog or continuous-time signals.

In a system, such as DOCSIS 3.1, where full-duplex and frequency division duplex are combined, any components, such as a frequency-domain multiplexing filtering device in the FDD system, can cause transmitter signal reflection (such as an echo) that severely limits the SNR that can be achieved in the FDX system. The dynamic range requirement of the downstream FDX transmission is dominated by the reflected transmission power (or transmitter echo) from the contiguous triplexer 656. In some aspects, the triplexer 656 has a reflection coefficient of about −10 dB. In this respect, the transmitter echo may not be filtered out in the receiver 654-1 (FDX RX) and the transmitter echo can limit the dynamic range of the full-duplex and frequency division duplex communication system 650. The input return loss looking into the F-connector 660 is determined by the triplexer 656, which adds complexity in the triplexer 656 design, thus resulting in lower yield.

The full-duplex and frequency division duplex communication system 650 utilizes two sets of power amplifiers, namely transmitters 652-1 and 652-2, where one power amplifier is configured for the upstream FDX transmission and one power amplifier is configured for the upstream FDD transmission. The two power amplifiers, however, add cost and complexity for digital domain stitching.

FIB. 6C illustrates an example combined architecture of full-duplex and frequency division duplex communication system 670 in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The full-duplex and frequency division duplex communication system 670 includes a transmitter 672, receivers 674-1 and 674-2, a triplexer 676 and a coupler 678. In some implementations, the full-duplex and frequency division duplex communication system 670 is, or includes a portion of, the communication device 310 as depicted in FIG. 3B. The transmitter 672 services both upstream FDD and upstream FDX transmissions and is coupled directly to an input of the coupler 678. In some implementations, the input of the transmitter 672 is coupled to a signal combiner (not shown) that combines the FDD and FDX signals to one pad. In this respect, the transmitter 672 may require additional power for driving the upstream signal compared to the transmitters 652-1 and 652-2 of FIG. 6B. The receiver 674-1 services downstream FDD transmissions and is coupled directly to a first output of the triplexer 676. The receiver 674-2 services downstream FDX transmissions and is coupled directly to a second output of the triplexer 676. The coupler 678 is coupled directly to the transmitter 672 and to an input of the triplexer 676 to facilitate the full-duplex transmissions to and from the triplexer 676 and transmitter 672, respectively. In some aspects, the full-duplex and frequency division duplex communication system 670 includes an F-connector 682. Note that any other type of connector may be used in various applications. In some aspects, the receivers 674-1 and 674-2 may process, demodulate, decode, and/or interpret signals received via the F-connector 682 and the triplexer 676.

The triplexer 676 services both upstream and downstream communications to and from the fiber node 135A. The receivers 674-1 and 674-2 receive and sample signals from the triplexer 676 and may respectively provide them to a processor (e.g., 330) for downstream processing. The received signals for downstream FDD processing may be filtered by the triplexer 676 to provide received signals within the downstream FDD frequency range (e.g., between 5-85 MHz) and passed on to the receiver 674-1. The received signals for downstream FDX processing may be filtered by the triplexer 676 to provide received signals within the downstream FDX frequency range (e.g., between 108-684 MHz) and passed on to the receiver 674-2. The processor 330 may generate digital signals for upstream transmission, and the transmitter 672 may generate amplified analog or continuous-time signals there from. The digital signals sent from the transmitter 672 for upstream FDD transmission may be filtered by the triplexer 676 to provide digital signals within the upstream FDD frequency range (e.g., between 720-1218 MHz) to the fiber node 135A. The digital signals sent from the transmitter 672 for upstream FDX transmission may be filtered by the triplexer 676 to pass digital signals within the upstream FDX frequency range (e.g., between 108-684 MHz) to the fiber node 135A. The transmitter may be implemented as a power amplifier to amplify the analog or continuous-time signals. In some implementations, the full-duplex and frequency division duplex communication system 670 in conjunction with the triplexer 676 can be implemented to support a time-division multiplex scheme.

In some implementations, the triplexer 676 may include a multiplexer using bandpass filters combined at a common input. For example, a first bandpass filter may be implemented as a low-pass filter to pass digital signals in the downstream FDD frequency range (e.g., between 5-85 MHz), a second bandpass filter may be implemented to pass digital signals in the FDX frequency range (e.g., between 108-684 MHz), and a third bandpass filter may be implemented as a high-pass filter to pass digital signals in the upstream FDD frequency range (e.g., between 720-1218 MHz). In other implementations, the triplexer 676 may be implemented as a filtering device that includes a diplexer and an additional filtering device coupled to the diplexer to pass digital signals in the three different frequency ranges discussed above.

As depicted in FIG. 6C, any components that cause reflection of power are not placed before the coupler 678 (e.g., between the coupler 678 and the F-connector 682) to prevent leakage of the reflected transmission power to the FDX receiver (e.g., 674-2). In some implementations, the full-duplex and frequency division duplex communication system 670 includes a termination resistor 680 for input matching. The termination resistor 680 is coupled directly to the triplexer 676. By adding additional termination in the filter (e.g., the triplexer 676), the input reflection of the full-duplex and frequency division duplex communication system 670 can be optimized across a broad bandwidth. For example, although the triplexer 676 is not utilized to drive signals in the upstream FDD frequency range (e.g., between 720-1218 MHz), the termination resistor 680 is utilized to match the input reflection corresponding to the FDD frequency range and to reduce leakage of reflected transmission power in this frequency range.

The TX to RX leakage path (e.g., from the transmitter 672 to the receiver 674-2 via the triplexer 676) is through the coupler 678. Isolation of the coupler 678 can be significantly low (<−40 dB) for isolation within the FDX frequency band of 100-684 MHz. In this respect, the dynamic range requirement of the downstream FDX transmission can be relaxed by about ˜30 dB compared to the architecture of the full-duplex and frequency division duplex communication system 650. Additionally, the design complexity of the triplexer 676 can be relaxed as well, which can lower the cost and increase the yield of production. This is because its reflection to the F-connector 682 is shielded by the loss of the coupler 678. As depicted in FIG. 6C, the full-duplex and frequency division duplex communication system 670 utilizes a single power amplifier (e.g., 672), which simplifies the system design and reduces cost.

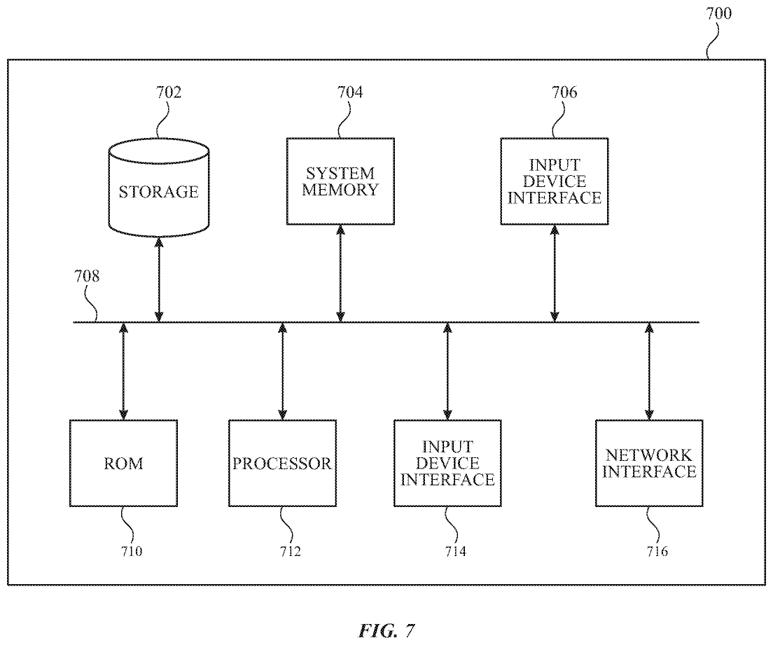

FIG. 7 conceptually illustrates an electronic system 700 with which one or more implementations of the subject technology may be implemented. The electronic system 700, for example, can be a desktop computer, a laptop computer, a tablet computer, a server, a switch, a router, a base station, a receiver, a phone, a personal digital assistant (PDA), or generally any electronic device that transmits signals over a network. The electronic system 700 may be, and/or may include one or more components of, one or more of the media converters 135A-C, one or more of the gateway devices 225A-I, one or more of the electronic devices 222A-I, 226A-I, 228A-I. Such an electronic system 700 includes various types of computer readable media and interfaces for various other types of computer readable media. The electronic system 700 includes a bus 708, one or more processing unit(s) 712, a system memory 704, a read-only memory (ROM) 710, a permanent storage device 702, an input device interface 714, an output device interface 706, one or more network interfaces 716, such as local area network (LAN) interfaces and/or wide area network interfaces (WAN), or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to a network (not shown) through one or more network interfaces 716, such as one or more LAN interfaces and/or WAN interfaces. In this manner, the electronic system 700 can be a part of a network of computers, such as a LAN, a WAN, an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system, comprising:
a coupler coupled to a terminal and configured to allow duplex transmissions of digital signals via the terminal;
a filtering device coupled to the coupler and configured to divide a downstream signal received through the coupler into a plurality of downstream signals associated with a plurality of frequency ranges;
a transmitter coupled to the coupler and configured to drive, through the coupler, an upstream signal comprising digital signals associated with the plurality of frequency ranges; and
a plurality of receivers coupled to the filtering device and configured to receive respective ones of the plurality of downstream signals.

2. The system of claim 1, wherein the upstream signal includes a first digital signal associated with a first frequency range of the plurality of frequency ranges for full-duplex (FDX) transmissions and a second digital signal associated with a second frequency range of the plurality of frequency ranges for upstream frequency division duplex (FDD) transmissions, the second frequency range being different than the first frequency range.

3. The system of claim 2, wherein the plurality of downstream signals includes a first downstream signal associated with the first frequency range for FDX transmissions and a second downstream signal associated with a third frequency range of the plurality of frequency ranges for downstream FDD transmissions, the third frequency range being different than the first frequency range.

4. The system of claim 2, wherein the plurality of receivers includes a first receiver that is coupled directly to a first output of the filtering device and is configured to receive a downstream signal associated with FDD transmissions.

5. The system of claim 2, wherein the plurality of receivers includes a second receiver that is coupled directly to a second output of the filtering device and is configured to receive a downstream signal associated with FDX transmissions.

6. The system of claim 2, wherein the coupler is coupled directly to an output of the transmitter and to an input of the filtering device to facilitate the FDX transmissions to and from the filtering device and the transmitter, respectively.

7. The system of claim 1, wherein the transmitter is coupled directly to an input of the coupler.

8. The system of claim 1, wherein an input of the transmitter is coupled to a signal combiner that combines digital signals associated with different frequency ranges into a common upstream signal.

9. The system of claim 1, wherein the terminal is an F-connector.

10. The system of claim 1, wherein the filtering device comprises a triplexer.

11. The system of claim 1, wherein the filtering device comprises a diplexer.

12. The system of claim 1, wherein the transmitter comprises a power amplifier.

13. The system of claim 1, wherein the filtering device is configured to pass bi-directional traffic of different frequency ranges for upstream and downstream transmissions through the coupler.

14. The system of claim 1, wherein the plurality of receivers is configured to receive and sample signals from the filtering device and respectively provide the signals to a processor for downstream processing of a corresponding frequency range.

15. The system of claim 1, further comprising a termination resistor coupled directly to the filtering device for input matching.

16. The system of claim 1, wherein the filtering device includes a multiplexer using a plurality of bandpass filters combined at a common input for passing a plurality of output signals of different frequencies.

17. A device, comprising:
a coupler configured to allow duplex transmissions of digital signals via a coaxial connector;
a filtering device configured to divide a downstream signal received through the coupler into a plurality of downstream signals associated with a plurality of frequency ranges;
a transmitter configured to drive, through the coupler, an upstream signal comprising digital signals associated with the plurality of frequency ranges; and
a plurality of receivers configured to receive respective ones of the plurality of downstream signals,
wherein the filtering device is interposed between the plurality of receivers and the coupler.

18. The device of claim 17, wherein the upstream signal includes a first digital signal associated with a first frequency range of the plurality of frequency ranges for full-duplex (FDX) transmissions and a second digital signal associated with a second frequency range of the plurality of frequency ranges for upstream frequency division duplex (FDD) transmissions, the second frequency range being different than the first frequency range.

19. The device of claim 18, wherein the plurality of downstream signals includes a first downstream signal associated with the first frequency range for FDX transmissions and a second downstream signal associated with a third frequency range of the plurality of frequency ranges for downstream FDD transmissions, the third frequency range being different than the first frequency range.

20. An apparatus, comprising:
a coupler coupled to a terminal and configured to allow duplex transmissions of digital signals via the terminal;
a filtering device coupled to the coupler and configured to divide a downstream signal received through the coupler into a plurality of downstream signals associated with a plurality of frequency ranges;
a first receiver coupled to the filtering device and configured to receive a first downstream signal associated with a first frequency range for downstream frequency division duplex transmissions;
a second receiver coupled to the filtering device and configured to receive a second downstream signal associated with a second frequency range for full-duplex transmissions, the second frequency range being different than the first frequency range; and
a transmitter coupled to the coupler and configured to drive, through the coupler, an upstream signal comprising digital signals associated with the first frequency range and a third frequency range for upstream frequency division duplex transmissions, the third frequency range being different than the first frequency range.
